(19) United States
(12) Patent Application Publication
(10) Pub. No.: US 2007/0268964 A1
(43) Pub. Date: Nov. 22, 2007

(54) Unit co-location-based motion estimation

(75) Inventor: Weidong Zhao, Bellevue, WA (US)

Correspondence Address: KLARQUIST SPARKMAN LLP, 121 S.W. SALMON STREET, SUITE 1600, PORTLAND, OR, 97204, US

(73) Assignee: Microsoft Corporation, Redmond, WA (US)

(21) Appl. No.: 11/440,238

(22) Filed: May 22, 2006

(51) Int. Cl. H04B 1/66; H04N 7/12

(52) U.S. Cl. 375/240.1; 375/240.12

(57) ABSTRACT

Techniques and tools for adaptive, unit co-location-based motion estimation are described. For example, in a layered block matching framework, a video encoder selects a start layer for motion estimation from among multiple available start layers. Each of the available start layers represents a reference video picture at a different spatial resolution. For a current macroblock in a current video picture, the encoder performs motion estimation relative to the reference video picture starting at the selected start layer. Or, a video encoder computes a contextual similarity metric for a current macroblock. The contextual similarity metric is based at least in part upon a texture measure for the current macroblock and a texture measure for one or more neighboring macroblocks. For the current macroblock, the motion estimation changes depending on the contextual similarity metric for the current macroblock.

### BACKGROUND

Digital video consumes large amounts of storage and transmission capacity. A typical raw digital video sequence includes 15 or 30 frames per second. Each frame can include tens or hundreds of thousands of pixels (also called pels), where each pixel represents a tiny element of the picture. In raw form, a computer commonly represents a pixel as a set of three samples totaling 24 bits. Thus, the number of bits per second, or bit rate, of a raw digital video sequence may be 5 million bits per second or more.

Many computers and computer networks lack the resources to process raw digital video. For this reason, engineers use compression (also called coding or encoding) to reduce the bit rate of digital video. Compression decreases the cost of storing and transmitting video by converting the video into a lower bit rate form. Decompression (also called decoding) reconstructs a version of the original video from the compressed form. A “codec” is an encoder/decoder system. Compression can be lossless, in which the quality of the video does not suffer, but decreases in bit rate are limited by the inherent amount of variability (sometimes called entropy) of the video data. Or, compression can be lossy, in which the quality of the video suffers, but achievable decreases in bit rate are more dramatic. Lossy compression is often used in conjunction with lossless compression—the lossy compression establishes an approximation of information, and the lossless compression is applied to represent the approximation.

A basic goal of lossy compression is to provide good rate-distortion performance. So, for a particular bit rate, an encoder attempts to provide the highest quality of video. Or, for a particular level of quality/fidelity to the original video, an encoder attempts to provide the lowest bit rate encoded video. In practice, considerations such as encoding time, encoding complexity, encoding resources, decoding time, decoding complexity, decoding resources, overall delay, and/or smoothness in quality/bit rate changes also affect decisions made in codec design as well as decisions made during actual encoding.

In general, video compression techniques include “intra-picture” compression and “inter-picture” compression. Intra-picture compression techniques compress individual pictures, and inter-picture compression techniques compress pictures with reference to a preceding and/or following picture (often called a reference or anchor picture) or pictures.

Inter-picture compression techniques often use motion estimation and motion compensation to reduce bit rate by exploiting temporal redundancy in a video sequence. Motion estimation is a process for estimating motion between pictures. In one common technique, an encoder using motion estimation attempts to match a current block of samples in a current picture with a candidate block of the same size in a search area in another picture, the reference picture. When the encoder finds an exact or “close enough” match in the search area in the reference picture, the encoder parameterizes the change in position between the current and candidate blocks as motion data (such as a motion vector (“MV”)). A motion vector is conventionally a two-dimensional value, having a horizontal component that indicates left or right spatial displacement and a vertical component that indicates up or down spatial displacement. Motion vectors can be in sub-pixel (e.g., half-pixel or quarter-pixel) increments, in which case an encoder performs interpolation on reference picture(s) to determine sub-pixel sample values. In general, motion compensation is a process of reconstructing pictures from reference picture(s) using motion data.

FIG. 1 illustrates motion estimation for part of a predicted picture in an example encoder. For an 8×8 block of samples, 16×16 block (often called a “macroblock”), or other unit of the current picture, the encoder finds a similar unit in a reference picture for use as a predictor. In FIG. 1, the encoder computes a motion vector for a 16×16 macroblock (115) in the current, predicted picture (110). The encoder searches in a search area (135) of a reference picture (130). Within the search area (135), the encoder compares the macroblock (115) from the predicted picture (110) to various candidate macroblocks in order to find a candidate macroblock that is a good match. The encoder outputs information specifying the motion vector to the predictor macroblock.

The encoder computes the sample-by-sample difference between the current unit and its motion-compensated prediction to determine a residual (also called error signal). The residual is frequency transformed, quantized, and entropy encoded. The overall bit rate of a predicted picture depends in large part on the bit rate of residuals. The bit rate of residuals is low if the residuals are simple (i.e., due to motion estimation that finds exact or good matches) or lossy compression drastically reduces the complexity of the residuals. Bits saved with successful motion estimation can be used to improve quality elsewhere or reduce overall bit rate. On the other hand, the bit rate of complex residuals can be higher, depending on the degree of lossy compression applied to reduce the complexity of the residuals.

If a predicted picture is used as a reference picture for subsequent motion compensation, the encoder reconstructs the predicted picture. When reconstructing residuals, the encoder reconstructs transform coefficients that were quantized using inverse quantization and performs an inverse frequency transform. The encoder performs motion compensation to compute the motion-compensated predictors, and combines the predictors with the reconstructed residuals.

Motion estimation has been studied extensively in both the academic world and industry, and numerous variations of motion estimation have been proposed. In general, encoders use a distortion metric during block matching motion estimation. A distortion metric helps an encoder evaluate the quality and rate costs associated with using a candidate block in a motion estimation choice. One common distortion metric is sum of absolute differences (“SAD”). To compute the SAD for a candidate block in a reference picture, the encoder computes the sum of the absolute values of the residual between the current and candidate blocks, where the residual is the sample-by-sample difference between the current block and the candidate block. For example, for block matching motion estimation for a current 16×16 macroblock CurrMBᵢⱼ, the encoder computes SAD relative to a match RefMBᵢⱼ in a reference video picture as follows:

$$SAD = {\sum }_{i , j = 0}^{15} \vert {CurrMB}_{i , j} - {RefMB}_{i , j} \vert . \qquad ( 1 )$$

For a perfect match, SAD is zero. Generally, the worse the match in an absolute distortion sense, the bigger the value of SAD. Sum of absolute Hadamard-transformed differences (“SAHD”) (or another sum of absolute transformed differences (“SATD”) metric), sum of squared errors (“SSE”), mean squared error (“MSE”), mean variance, and rate-distortion cost (e.g., LaGrangian rate-distortion cost) are other distortion metrics.

Encoders typically spend a large proportion (in some cases, more than 70%) of encoding time performing motion estimation, attempting to find good matches and thereby improve rate-distortion performance. For example, if a video encoder computes SAD for every possible integer-pixel offset in a 128×64 sample search window, the encoder computes SAD 8,192 times. Generally, using a large search range in a reference picture improves the chances of an encoder finding a good match. In a full search, however, the encoder compares a current block against all possible spatially displaced blocks in the large search range. In most scenarios, an encoder lacks the time or resources to check every possible motion vector in a large search range for every block or macroblock to be encoded, even with a single instruction multiple data (“SIMD”) implementation. The computational cost of extensive searching through a search range for the best motion vector can be prohibitive, especially for real-time encoding scenarios or encoding with mobile or small computing devices, or when a codec allows motion vectors for large displacements. Various techniques help encoders speed up motion estimation.

In hierarchical motion estimation, an encoder finds one or more motion vectors at a low resolution (e.g., using a 4:1 downsampled picture), scales up the motion vector(s) to a higher resolution (e.g., integer-pixel), finds one or more motion vectors at the higher resolution in neighborhood(s) around the scaled up motion vector(s), and so on. While this allows the encoder to skip exhaustive searches at the higher resolutions, it can result in wasteful long searches at the low resolution when there is little or no justification for the long searches. Such hierarchical motion estimation also fails to adapt search range to changes in motion characteristics in the video content being encoded.

For example, one prior motion estimation implementation (adapted for desktop computing environments) uses a 3-layer hierarchical approach, with an integer-pixel (1:1) layer, a layer downsampled by a factor of two horizontally and vertically (2:1), and a layer downsampled by a factor of four horizontally and vertically (4:1). According to this implementation, a macroblock covers the same number of samples (i.e., 16×16=256) at each of the layers, effectively covering 4 times as much area at the 2:1 layer compared to the 1:1 layer, and 16 times as much area at the 4:1 layer compared to the 1:1 layer. Starting at the 4:1 layer, the encoder performs spiral searches around two “seeds”—the predicted motion vector (mapped to 4:1 space) and the zero-value motion vector—to find the best candidate match. At the 2:1 layer, the encoder performs spiral searches around the predicted motion vector (mapped to 2:1 space), the zero-value motion vector, and the best 4:1 layer motion vector (mapped to 2:1 space). Next, at the 1:1 layer, the encoder performs spiral searches around three seeds—the predicted motion vector (mapped to 1:1 space), the zero-value motion vector, and the best 2:1 layer motion vector (mapped to 1:1 space). The encoder then performs sub-pixel motion estimation. While such motion estimation is effective in many scenarios, it suffers from motion vector “washout” effects in some cases. Washout effects are essentially due to high frequency details of texture at a higher resolution (e.g., 1:1) that get “smoothed out” due to downsampling. A good match at a lower resolution (e.g., 4:1) may be a “spurious good” match. When mapped back to the higher resolution, the previously smoothed-out details can be so different between the reference and current macroblocks that the match is far from being the good seed candidate suggested by the lower resolution match. Washout effects are a characteristic of downsampling schemes.

Another prior motion estimation implementation (also adapted for desktop computing environments) uses a 2-layer hierarchical approach, with an integer-pixel (1:1) layer and a layer downsampled by a factor of four horizontally and vertically (4:1). According to this implementation, a macroblock covers the same effective area at the 1:1 layer and the 4:1 layer. In other words, the macroblock includes 16×16=256 samples at the 1:1 layer and 4×4=16 samples at the 4:1 layer, due to downsampling by a factor of four horizontally and vertically. At the 4:1 layer, the encoder performs a full search through a 32×16 sample search range to find two seeds. At each of the 32×16=512 offsets, the encoder computes a 16-point SAD for the 4×4 macroblock. Next, at the 1:1 layer, the encoder performs 25-point square (5×5) searches around seeds—the predicted motion vector (mapped to 1:1 space), the zero-value motion vector, and the best 4:1 layer seed motion vectors (mapped to 1:1 space). The encoder then computes a gradient from the motion estimation results and performs sub-pixel motion estimation in the area indicated by the gradient. Motion estimation according to this implementation reduces computational complexity/increases speed of motion estimation by as much as a factor of 100 compared to a full search at the 1:1 layer, while still providing reasonable peak signal-to-noise ratio (“PSNR”) performance. Moreover, such motion estimation does not suffer from motion vector “washout” effects to the same extent as the 3-layer approach described above, since two seeds are output from the 4:1 layer rather than one. The motion estimation can still result in poor seeding, however. And, the improvement in encoding speed/computational complexity may still not suffice in some scenarios, e.g., scenarios with relatively severe processing power constraints (such as mobile-based devices) and/or delay constraints (such as real-time encoding).

Still other encoders dynamically adjust search range when performing non-hierarchical motion estimation for a current block or macroblock of a current picture by considering the motion vectors of immediately spatially adjacent blocks in the current picture. Such encoders can speed up motion estimation by tightly focusing the motion vector search process for the current block or macroblock. However, in certain scenarios (e.g., strong localized motion, discontinuous motion or other complex motion), such motion estimation can fail to provide adequate performance.

Aside from these techniques, many encoders use specialized motion vector search patterns or other strategies deemed likely to find a good match in an acceptable amount of time. Various other techniques for speeding up or otherwise improving motion estimation have been developed. Given the critical importance of video compression to digital video, it is not surprising that motion estimation is a richly developed field. Whatever the benefits of previous motion estimation techniques, however, they do not have the advantages of the following techniques and tools.

### SUMMARY

The present application is directed to techniques and tools for adaptive motion estimation. For example, a video encoder performs motion estimation in which the amount of resources spent on block matching for a current unit (e.g., block, macroblock) varies depending on how similar the current unit is to neighboring units (e.g., blocks, macroblocks). This helps increase encoding speed and reduce computational complexity in scenarios such as those with processing power constraints and/or delay constraints.

According to a first set of the described techniques and tools, a video encoder or other tool selects a start layer for motion estimation from among multiple available start layers. Each of the available start layers represents a reference video picture at a different spatial resolution. For a current unit in a current video picture, the tool performs motion estimation starting at the selected start layer and continuing until the motion estimation completes for the current unit relative to the reference video picture at a final layer.

According to a second set of the described techniques and tools, a video encoder or other tool computes a contextual similarity metric for a current unit. The current unit has one or more neighboring units in the current video picture. The contextual similarity metric is based at least in part upon texture measures (e.g., SAD) for the current unit and the one or more neighboring units. For the current unit, the tool performs motion estimation that changes depending on the contextual similarity metric for the current unit.

According to a third set of the described techniques and tools, a video encoder includes a motion estimation module. In motion estimation, a reference video picture is represented at multiple layers having spatial resolutions that vary from layer to layer by a factor of two horizontally and a factor of two vertically. Each of the layers has an associated search pattern, and at least two of the layers have different associated search patterns.

The foregoing and other objects, features, and advantages of the described techniques and tools and others will become more apparent from the following detailed description, which proceeds with reference to the accompanying figures.

### BRIEF DESCRIPTION OF THE DRAWINGS

FIG. 1 is a diagram showing motion estimation according to the prior art.

FIG. 2 is a block diagram of a suitable computing environment in which several described embodiments may be implemented.

FIG. 3 is a block diagram of a video encoder system in conjunction with which several described embodiments may be implemented.

FIG. 4 is a diagram showing a 4:2 layered block matching framework.

FIG. 5 is a pseudocode listing for an example motion estimation routine for layered block matching.

FIG. 6 is a diagram of an example 4-point walking diamond search.

FIG. 7 is a diagram illustrating different contextual similarity metric cases.

FIG. 8 is a pseudocode listing for an example routine for selecting a motion estimation start layer based upon a contextual similarity metric for a current unit.

FIG. 9 is a flowchart of a technique for selecting motion estimation start layers.

FIG. 10 is a flowchart of a technique for adjusting motion estimation based on contextual similarity metrics.

FIGS. 11a and 11b are tables illustrating improved performance of unit co-location-based motion estimation on test video sequences.

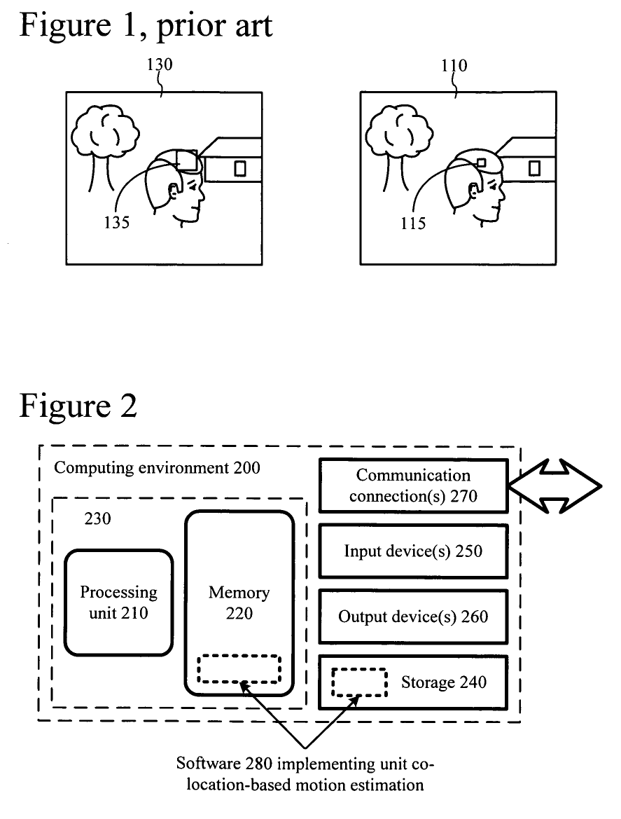

### DETAILED DESCRIPTION

The present application relates to techniques and tools for performing unit co-location-based motion estimation. In various described embodiments, a video encoder performs adaptive motion estimation in which the amount of resources spent on block matching for a current unit varies depending on how similar the current unit is to neighboring units.

Various alternatives to the implementations described herein are possible. For example, certain techniques described with reference to flowchart diagrams can be altered by changing the ordering of stages shown in the flowcharts, by repeating or omitting certain stages, etc.

The various techniques and tools described herein can be used in combination or independently. Different embodiments implement one or more of the described techniques and tools. Various techniques and tools described herein can be used for motion estimation in a tool other than video encoder, for example, an image synthesis or interpolation tool.

Some of the techniques and tools described herein address one or more of the problems noted in the Background. Typically, a given technique/tool does not solve all such problems. Rather, in view of constraints and tradeoffs in encoding time, resources and/or quality, the given technique/tool improves performance for a particular motion estimation implementation or scenario.

### I. Computing Environment.

FIG. 2 illustrates a generalized example of a suitable computing environment (200) in which several of the described embodiments may be implemented. The computing environment (200) is not intended to suggest any limitation as to scope of use or functionality, as the techniques and tools may be implemented in diverse general-purpose or special-purpose computing environments.

With reference to FIG. 2, the computing environment (200) includes at least one processing unit (210) and memory (220). In FIG. 2, this most basic configuration (230) is included within a dashed line. The processing unit (210) executes computer-executable instructions and may be a real or a virtual processor. In a multi-processing system, multiple processing units execute computer-executable instructions to increase processing power. The memory (220) may be volatile memory (e.g., registers, cache, RAM), non-volatile memory (e.g., ROM, EEPROM, flash memory, etc.), or some combination of the two. The memory (220) stores software (280) implementing an encoder with one or more of the described techniques and tools for unit co-location-based motion estimation.

A computing environment may have additional features. For example, the computing environment (200) includes storage (240), one or more input devices (250), one or more output devices (260), and one or more communication connections (270). An interconnection mechanism (not shown) such as a bus, controller, or network interconnects the components of the computing environment (200). Typically, operating system software (not shown) provides an operating environment for other software executing in the computing environment (200), and coordinates activities of the components of the computing environment (200).

The storage (240) may be removable or non-removable, and includes magnetic disks, magnetic tapes or cassettes, CD-ROMs, DVDs, or any other medium which can be used to store information and which can be accessed within the computing environment (200). The storage (240) stores instructions for the software (280) implementing the video encoder.

The input device(s) (250) may be a touch input device such as a keyboard, mouse, pen, or trackball, a voice input device, a scanning device, or another device that provides input to the computing environment (200). For audio or video encoding, the input device(s) (250) may be a sound card, video card, TV tuner card, or similar device that accepts audio or video input in analog or digital form, or a CD-ROM or CD-RW that reads audio or video samples into the computing environment (200). The output device(s) (260) may be a display, printer, speaker, CD-writer, or another device that provides output from the computing environment (200).

The communication connection(s) (270) enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The techniques and tools can be described in the general context of computer-readable media. Computer-readable media are any available media that can be accessed within a computing environment. By way of example, and not limitation, with the computing environment (200), computer-readable media include memory (220), storage (240), communication media, and combinations of any of the above.

The techniques and tools can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment.

For the sake of presentation, the detailed description uses terms like “decide” and “consider” to describe computer operations in a computing environment. These terms are high-level abstractions for operations performed by a computer, and should not be confused with acts performed by a human being. The actual computer operations corresponding to these terms vary depending on implementation.

### II. Generalized Video Encoder.

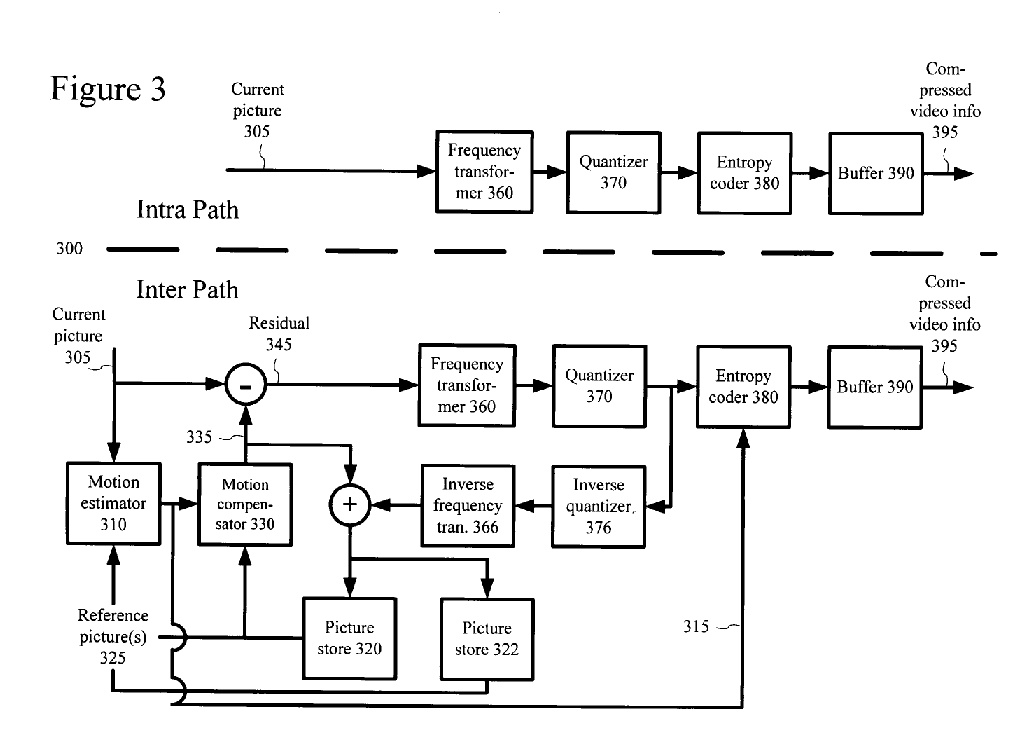

FIG. 3 is a block diagram of a generalized video encoder (300) in conjunction with which some described embodiments may be implemented. The encoder (300) receives a sequence of video pictures including a current picture (305) and produces compressed video information (395) as output to storage, a buffer, or a communications connection. The format of the output bitstream can be a Windows Media Video or VC-1 format, MPEG-x format (e.g., MPEG-1, MPEG-2, or MPEG-4), H.26x format (e.g., H.261, H.262, H.263, or H.264), or other format.

The encoder (300) processes video pictures. The term picture generally refers to source, coded or reconstructed image data. For progressive video, a picture is a progressive video frame. For interlaced video, a picture may refer to an interlaced video frame, the top field of the frame, or the bottom field of the frame, depending on the context. The encoder (300) is block-based and use a 4:2:0 macroblock format for frames, with each macroblock including four 8×8 luminance blocks (at times treated as one 16×16 macroblock) and two 8×8 chrominance blocks. For fields, the same or a different macroblock organization and format may be used. The 8×8 blocks may be further sub-divided at different stages, e.g., at the frequency transform and entropy encoding stages. The encoder (300) can perform operations on sets of samples of different size or configuration than 8×8 blocks and 16×16 macroblocks. Alternatively, the encoder (300) is object-based or uses a different macroblock or block format.

Returning to FIG. 3, the encoder system (300) compresses predicted pictures and intra-coded, key pictures. For the sake of presentation, FIG. 3 shows a path for key pictures through the encoder system (300) and a path for predicted pictures. Many of the components of the encoder system (300) are used for compressing both key pictures and predicted pictures. The exact operations performed by those components can vary depending on the type of information being compressed.

A predicted picture (e.g., progressive P-frame or B-frame, interlaced P-field or B-field, or interlaced P-frame or B-frame) is represented in terms of prediction from one or more other pictures (which are typically referred to as reference pictures or anchors). A prediction residual is the difference between predicted information and corresponding original information. In contrast, a key picture (e.g., progressive I-frame, interlaced I-field, or interlaced I-frame) is compressed without reference to other pictures.

If the current picture (305) is a predicted picture, a motion estimator (310) estimates motion of macroblocks or other sets of samples of the current picture (305) with respect to one or more reference pictures. The picture store (320) buffers a reconstructed previous picture (325) for use as a reference picture. When multiple reference pictures are used, the multiple reference pictures can be from different temporal directions or the same temporal direction. The encoder system (300) can use the separate stores (320) and (322) for multiple reference pictures.

The motion estimator (310) can estimate motion by full-sample, ½-sample, ¼-sample, or other increments, and can switch the precision of the motion estimation on a picture-by-picture basis or other basis. The motion estimator (310) (and compensator (330)) also can switch between types of reference picture sample interpolation (e.g., between bicubic and bilinear) on a per-picture or other basis. The precision of the motion estimation can be the same or different horizontally and vertically. The motion estimator (310) outputs as side information motion information (315). The encoder (300) encodes the motion information (315) by, for example, computing one or more motion vector predictors for motion vectors, computing differentials between the motion vectors and motion vector predictors, and entropy coding the differentials. To reconstruct a motion vector, a motion compensator (330) combines a motion vector predictor with differential motion vector information.

The motion compensator (330) applies the reconstructed motion vectors to the reconstructed (reference) picture(s) (325) when forming a motion-compensated current picture (335). The difference (if any) between a block of the motion-compensated current picture (335) and corresponding block of the original current picture (305) is the prediction residual (345) for the block. During later reconstruction of the current picture, reconstructed prediction residuals are added to the motion compensated current picture (335) to obtain a reconstructed picture that is closer to the original current picture (305). In lossy compression, however, some information is still lost from the original current picture (305). Alternatively, a motion estimator and motion compensator apply another type of motion estimation/compensation.

A frequency transformer (360) converts spatial domain video information into frequency domain (i.e., spectral, transform) data. For block-based video pictures, the frequency transformer (360) applies a discrete cosine transform (“DCT”), variant of DCT, or other forward block transform to blocks of the samples or prediction residual data, producing blocks of frequency transform coefficients. Alternatively, the frequency transformer (360) applies another conventional frequency transform such as a Fourier transform or uses wavelet or sub-band analysis. The frequency transformer (360) may apply an 8×8, 8×4, 4×8, 4×4 or other size frequency transform.

A quantizer (370) then quantizes the blocks of transform coefficients. The quantizer (370) applies uniform, scalar quantization to the spectral data with a step-size that varies on a picture-by-picture basis or other basis. The quantizer (370) can also apply another type of quantization to spectral data coefficients, for example, a non-uniform, vector, or non-adaptive quantization. In addition to adaptive quantization, the encoder (300) can use frame dropping, adaptive filtering, or other techniques for rate control.

When a reconstructed current picture is needed for subsequent motion estimation/compensation, an inverse quantizer (376) performs inverse quantization on the quantized spectral data coefficients. An inverse frequency transformer (366) performs an inverse frequency transform, producing reconstructed prediction residuals (for a predicted picture) or samples (for a key picture). If the current picture (305) was a key picture, the reconstructed key picture is taken as the reconstructed current picture (not shown). If the current picture (305) was a predicted picture, the reconstructed prediction residuals are added to the motion-compensated predictors (335) to form the reconstructed current picture. One or both of the picture stores (320, 322) buffers the reconstructed current picture for use in subsequent motion-compensated prediction. In some embodiments, the encoder applies a de-blocking filter to the reconstructed picture to adaptively smooth discontinuities and other artifacts in the picture.

The entropy coder (380) compresses the output of the quantizer (370) as well as certain side information (e.g., motion information (315), quantization step size). Typical entropy coding techniques include arithmetic coding, differential coding, Huffman coding, run length coding, LZ coding, dictionary coding, and combinations of the above. The entropy coder (380) typically uses different coding techniques for different kinds of information, and can choose from among multiple code tables within a particular coding technique.

The entropy coder (380) provides compressed video information (395) to the multiplexer (“MUX”) (390). The MUX (390) may include a buffer, and a buffer level indicator may be fed back to a controller. Before or after the MUX (390), the compressed video information (395) can be channel coded for transmission over the network. The channel coding can apply error detection and correction data to the compressed video information (395).

A controller (not shown) receives inputs from various modules such as the motion estimator (310), frequency transformer (360), quantizer (370), inverse quantizer (376), entropy coder (380), and buffer (390). The controller evaluates intermediate results during encoding, for example, estimating distortion and performing other rate-distortion analysis. The controller works with modules such as the motion estimator (310), frequency transformer (360), quantizer (370), and entropy coder (380) to set and change coding parameters during encoding. When an encoder evaluates different coding parameter choices during encoding, the encoder may iteratively perform certain stages (e.g., quantization and inverse quantization) to evaluate different parameter settings. The encoder may set parameters at one stage before proceeding to the next stage. Or, the encoder may jointly evaluate different coding parameters, for example, jointly making an intra/inter block decision and selecting motion vector values, if any, for a block. The tree of coding parameter decisions to be evaluated, and the timing of corresponding encoding, depends on implementation.

The relationships shown between modules within the encoder (300) indicate general flows of information in the encoder; other relationships are not shown for the sake of simplicity. In particular, FIG. 3 usually does not show side information indicating the encoder settings, modes, tables, etc. used for a video sequence, picture, macroblock, block, etc. Such side information, once finalized, is sent in the output bitstream, typically after entropy encoding of the side information.

Particular embodiments of video encoders typically use a variation or supplemented version of the generalized encoder (300). Depending on implementation and the type of compression desired, modules of the encoder can be added, omitted, split into multiple modules, combined with other modules, and/or replaced with like modules. For example, the controller can be split into multiple controller modules associated with different modules of the encoder. In alternative embodiments, encoders with different modules and/or other configurations of modules perform one or more of the described techniques.

### III. Unit Co-Location-Based Motion Estimation.

Prior hierarchical motion estimation schemes can dramatically reduce the computational complexity of motion estimation, thereby increasing speed. Such improvements are insufficient in some scenarios, however, such as encoding scenarios with relatively severe processing power constraints (e.g., mobile-based devices) and/or delay constraints (e.g., real-time encoding). In general, given processor and/or time constraints on encoding, a motion estimation scheme attempts to exploit shortcuts to reduce the amount of searching and block matching while still achieving acceptable performance for a given bit rate and quality. This section describes motion estimation techniques and tools customized for encoding in real time and/or with a mobile or small computing device, but the techniques and tools can instead be used in other contexts. The techniques and tools can be used in combination or separately.

According to a first set of techniques and tools, an encoder generates a contextual similarity metric and uses the metric in motion estimation decisions. For a current unit (e.g., block, macroblock) of video, the metric takes into account statistical features associated with the current unit and/or one or more neighboring units (e.g., blocks, macroblocks). For example, the metric is based on variance, covariance, or some other statistical feature of motion vectors or other motion estimation information of the neighboring unit(s). Motion vectors and block matching modes for a region of a video picture often exhibit strong spatial correlation. If so, a small search window often suffices to propagate a best-match motion vector from neighboring units to the current unit.

The contextual similarity metric can also be based on SAD values or some other statistical feature of the matches for the neighboring unit(s) and the current unit (assuming the predicted motion vector is used for the current unit). When the current unit represents content for one spatial region, with the neighboring units representing content for a different region, consistent motion of the neighboring units can inaccurately forecast the motion for the current unit. Considering SAD values for the current unit and neighboring units helps identify certain types of region transitions, allowing the encoder to use a larger search window (or lower spatial resolution layer) in motion estimation for the transition content.

According to a second set of techniques and tools, an encoder uses a pyramid structured set of layers in hierarchical motion estimation. The layers of the pyramid can be in resolution multiples of two horizontally and vertically in the search space. For example, the pyramid includes 8:1, 4:1, 2:1, 1:1, 1:2, and 1:4 layers. Each of the layers of the pyramid can have a specific search pattern associated with it. For example, the search patterns are defined considering factors such as the efficiency of wide searching at the respective layers and the extent to which widening the search range at a given layer improves the chance of finding a better motion vector at the layer.

According to a third set of techniques and tools, an encoder utilizes a switching mechanism to set a start layer for layered motion estimation. The switching mechanism allows the encoder to branch into any one of several available start layers (e.g., 8:1 or 2:1 or 1:4) for the layered motion estimation. For example, the switching depends on a contextual similarity metric that maps to an estimated search range and/or start layer. In some implementations, when setting the start layer for motion estimation for a current macroblock, the mapping takes into account statistical similarity among neighboring motion vectors, statistical similarity of SAD values for neighboring macroblocks, and the predicted SAD value for the current macroblock. Statistically strong motion vector correlation causes the encoder to start at a higher spatial resolution layer (such as 1:2 or 1:4) and/or use a small or even zero-size search window, so as to reduce the number of block matching operations. On the other hand, statistically weak motion vector correlation or detection of a transition to a less spatially correlated region causes the encoder to start at a lower spatial resolution layer (such as 8:1 or 4:1) and/or use a bigger search window, so as to cover a larger region of search.

A. Example Combined Implementations.

This section describes example combined implementations.

1. Example Layered Block Matching Framework.

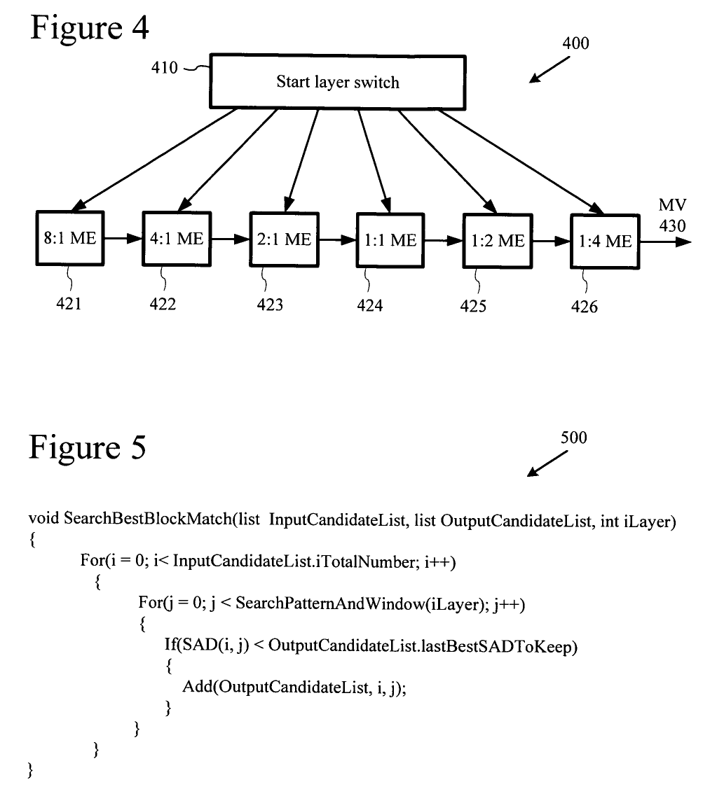

FIG. 4 shows a 4:2 layered block matching framework (400). The framework (400) includes an 8:1 layer (421), a 4:1 layer (422), a 2:1 layer (423), a 1:1 layer (424), a 1:2 layer (425) and a 1:4 layer (426). The result of motion estimation according to the framework (400) is one or more motion vectors (430). The framework (400) thus includes three downsampled layers (8:1, 4:1, and 2:1), an integer-pixel layer (1:1), and two sub-sampled layers (1:2 and 1:4). 8:1 is the “highest” layer of the pyramid but has the lowest spatial resolution. 1:4 is the “lowest” layer of the pyramid but has the highest spatial resolution. The three downsampled layers and integer-pixel layer have values at integer locations (or some subset of integer locations). Fractional offset values for the two sub-sampled layers are computed by interpolation.

In general, the 4:2 layered block matching framework (400) operates as follows. The encoder starts from an initial layer (which is any one of multiple available start layers) and performs block matching on the layer. For one possible start layer (namely, the 8:1 layer), the encoder performs a full search in a 32×16 sample window around a predicted motion vector and keeps a large number (e.g., 24) of the best candidates as output for the next layer. For other possible start layers, the encoder performs block matching according to a different search pattern and/or keeps a different number of candidates as seeds for the next layer. The encoder continues down the layers until the encoder completes motion estimation for the lowest layer (namely, the 1:4 layer), and the best matching motion vector for the lowest layer is used as the final motion vector for the current unit.

FIG. 5 shows an example motion estimation routine for motion estimation at a particular layer according to the example combined implementations. In general, the motion estimation layers are treated symmetrically, aside from the start layer and final layer. The routine SearchBestBlockMatch accepts as input a list of seeds and an integer identifying a layer for motion estimation. For each of the candidates in the list of seeds, the encoder performs a search according to a search pattern associated with the layer. For any offset j in the search pattern, the encoder computes SAD and compares the SAD value to a running list of the output seeds for the layer. For example, the output seed list is sorted by SAD value. If the SAD value for the current offset j is less than the worst match currently in the output seed list, the encoder updates the output seed list to add the current offset and remove (if necessary) the seed that is no longer one of the best for the layer. The seeds output for a layer are mapped into the resolution of the subsequent layer of motion estimation. For example, motion vectors output as seeds from the 8:1 layer are mapped to motion vectors seeds for input to the 4:1 layer by doubling the sizes of the motion vectors.

Alternatively, the framework includes other and/or additional layers. In different implementations, one or more of the layers has a different search pattern than described above. Or, the encoder uses a different mechanism and/or matching metric than described above for motion estimation at a given layer.

2. Example SAD Computation.

The encoder computes SAD values for candidate matches at the different layers in the 4:2 layered block matching framework (400). The encoder generally computes SAD as shown in equation (1) above, but the size of the current unit decreases for search at the downsampled layers. For the downsampled layers, a current macroblock has indices i and j of 0 to MBSize-1, where MBSize is the downsampled size of the original 16×16 macroblock. So, at the 8:1 layer, the current macroblock has a size of 2×2. For the sub-sampled layers, the search size of the current macroblock stays at 16×16.

For the sake of comparison, one of the prior motion estimation schemes described in the Background performs a full search for 4×4 block matching operations in a 32×16 sample search window at a 4:1 layer. This provides a dramatic complexity reduction compared to a corresponding full search for 16×16 block matching operations in a 128×64 sample search window at a 1:1 layer. At the 4:1 layer, there are 32×16=512 block matching operations (rather than 128×64=8192), and each block matching operation compares 16 points (rather than 256). If a single 16×16 block matching operation at the 1:1 layer is an effective SAD (“ESAD”), the full search motion estimation for the 1:1 layer involves 8192 ESADs. In contrast, the full search motion estimation for the 4:1 layer involves 512×(16/256)=32 ESADs.

Extending this analysis to the example combined implementations, consider a full search for 2×2 block matching operations in a 16×8 sample search window at the 8:1 layer. At the 8:1 layer, there are 16×8=128 block matching operations, each comparing 4 points. So, full search motion estimation for the 8×1 layer involves 128×(4/256)=2 ESADs

One downside of computing SAD values in the downsampled layers is that high frequency contributions have been filtered out. This can result in misidentification of the best match candidates for a current unit, when the encoder incorrectly identifies certain candidates as being better than the eventual, true best match. One approach to dealing with this concern is to pass more seed values from higher downsampled layers to lower layers in the motion estimation. Keeping multiple candidate seeds from a lower resolution search helps reduce the chance of missing out on the truly good candidate seeds. In the example combined implementations, the encoder outputs 24 seed values from the 8:1 layer to the 4:1 layer.

Alternatively, the encoder uses a different matching metric (e.g., SATD, MSE) than described above for motion estimation at a given layer.

3. Example Layer-Specific Search Patterns.

In the example combined implementations, for each layer, the encoder uses a particular search window and search pattern. In many cases, the search window/pattern surrounds a search seed from the higher layer. As a theoretical matter, the specification of the search window/pattern for a layer is determined statistically by minimizing the number of search points while maximizing the probability of maintaining the final best block match. More intuitively, for a given layer, a search window/pattern is set so that incrementally increasing the size of the search window/pattern has diminishing returns in terms of improving the chance of finding the final best block match. The search patterns/windows used depend on implementation. The following table shows example search patterns/windows for a 4:2 block matching framework.

TABLE 1
Example search patterns for different layers.

| Layer | Search Pattern | # of Output Seeds |
|---|---|---|
| 8:1 | Full search | 24 |
| 4:1 | 9-point square search (3 × 3 square) | 4 |
| 2:1 | 4-point walking search | 1 |
| 1:1 | 4-point walking search | 1 |
| 1:2 | 4-point walking search | 1 (can be final MV) |
| 1:4 | 4-point walking search | 1 (can be final MV) |

For the top layer (8:1), the encoder performs a full search in a 16×8 sample window, which corresponds to a maximum allowed search window of 128×64 samples at the 1:1 layer. At the 4:1 layer, the encoder performs a 9-point search in a 3×3 square around each seed location. At each of the remaining layers (namely, 2:1, 1:1, 1:2, and 1:4 layers), the encoder performs a 4-point “walking diamond” search around each seed location. The number of candidate seeds at these remaining layers is somewhat limited, and the walking diamond searches often result in the encoder finding a final best match without much added computation or speed cost.

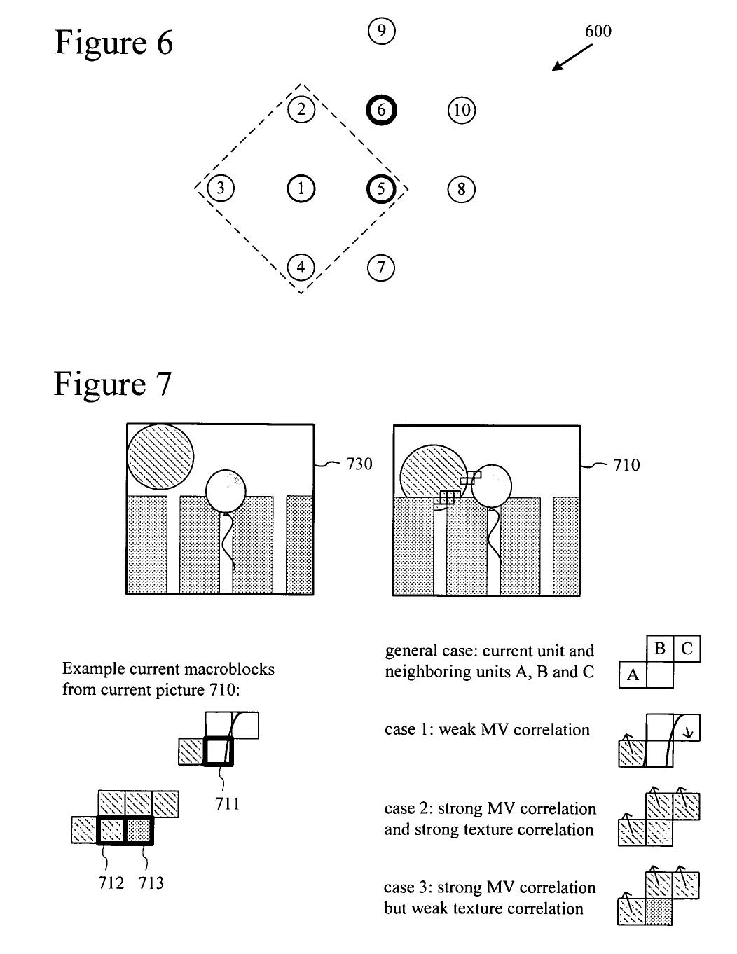

FIG. 6 shows a diagram of an example 4-point walking diamond search. With a walking diamond search, the encoder starts at a seed location 1. For example, the seed is a seed from a downsampled layer mapped to the current motion estimation layer. The encoder computes SAD for seed location 1, then continues at surrounding locations 2, 3, 4 and 5, respectively. The walking diamond search is dynamic, which lets the encoder explore neighboring areas until the encoder finds a local minimum among the computed SAD values. In FIG. 6, suppose the location with the lowest SAD in the first diamond is location 5. The encoder computes SAD for surrounding locations 6, 7 and 8. (SAD was already computed for the seed location 1.) The SAD value of location 6 is lower than that of location 5, so the encoder continues by computing SAD values for surrounding locations 9 and 10 (SAD was already computed and cached for locations 2 and 5). In the example of FIG. 6, the encoder stops after determining that location 6 is a local minimum. Or, the encoder continues evaluation in the direction of the lowest SAD value among neighboring locations, but stops motion estimation if all four neighbor locations for the new center location have been evaluated, which indicates convergence. Or, the encoder uses some other exit condition for a walking search.

Alternatively, one or more of the layers has a different search pattern than described above and/or the encoder uses a different matching metric than described above. The size and shape of a search pattern, as well as exit conditions for the search pattern, can be adjusted depending on implementation to change the amount of resources to be used in block matching with the search pattern. Also, the number of seeds at a given layer can be adjusted depending on implementation to change the amount of resources to be used in block matching at the layer. Moreover, at a given layer, the encoder can consider the predicted motion vector (e.g., component-wise median of contextual motion vectors, mapped to the appropriate scale) and zero-value motion vector as additional seeds.

4. Switching Start Layers.

In the example combined implementations, the initial layer to start motion estimation need not be the top layer. The motion estimation can start at any of multiple available layers. Referring again to FIG. 4, the 4:2 layered block matching framework (400) includes a start layer switch (410) engine or mechanism. With the start layer switch (410), the encoder selects between multiple available start layers for the motion estimation. For example, the encoder selects a start layer from among the 8:1, 4:1, 2:1, 1:1, 1:2, and 1:4 layers.

The encoder performs the switching based upon analysis of motion vectors of neighboring units (e.g., blocks, macroblocks) and/or analysis of texture of the current unit and neighboring units. The next section describes example contextual similarity metrics used for start layer switching decisions. In the example combined implementations, the search window size of the start layer basically defines the scale of the ultimate search range (not considering “walking” outside the range). In particular, when the start layer is the top layer (in FIG. 4, the 8:1 layer), the encoder conducts a full search, and the scale of the search window is the original full search window, accounting for downsampling to the top layer. This is appropriate when the current region (including current and neighboring units) is dominated by texture transitions or un-correlated motion. On the other hand, in a region with highly correlated motion, the encoder exploits the spatial correlation by starting motion estimation at a higher spatial resolution layer and using a much smaller search window, thus reducing the overall search cost.

Compared to techniques in which an encoder changes search range size within a given reference picture at some spatial resolution (e.g., adjusting search range within a 1:4 resolution reference picture), switching start layers allows the encoder to increase range efficiently at a high layer such as 8:1 for a full search or 4:1 for a 3×3 search. The encoder can then selectively drill down on promising motion estimation results regardless of where they are within the starting search range.

Alternatively, the encoder considers other and/or additional criteria when selecting start layers. Or, the encoder selects a start layer on something other than a unit-by-unit basis.

5. Example Contextual Similarity Metrics.

When determining the start layer for motion estimation for a current unit in the 4:2 layered block matching framework (400), the encoder considers a contextual similarity metric that suggests a primary search region for the current unit. This helps the encoder smoothly switch between different start layers from block-to-block, macroblock-to-macroblock, or on some other basis. The contextual similarity metric measures statistical similarity among motion vectors of neighboring units. The contextual similarity metric also attempts to quantify how uniform the texture is between the current unit and neighboring units, and among neighboring units, using SAD as a convenient indicator of texture correlation.

In the example combined implementations, the encoder computes MVSS for a current unit (e.g., macroblock or block) as a measure of statistical similarity between motion vectors of neighboring units. As shown in the “general case” of FIG. 7, the encoder considers motion vectors of the unit A to the left of the current unit, the unit B above the current unit, and the unit C above and to the right of the current unit.

$$MVSS = {max}_{a = L , U , UR} \vert {mv}_{a} - {mv}_{median} \vert , \qquad ( 2 )$$

where mv_{median} is the component-wise median of the available neighboring motion vectors. If one of the neighboring units is outside of the current picture, no motion vector for it is considered. If one of the neighboring units is intra-coded, no motion vector for it is considered. (Although intra-coded units are not considered, the encoder gives different emphasis to MVSS depending on how many inter-coded units are actually involved in the computation. The more inter-coded units, the less the encoder discounts the MVSS result.) Alternatively, the encoder assigns an intra-coded unit a zero-value motion vector. MVSS thus measures the maximum difference between a given one of the available neighboring motion vectors and the median values of the available neighboring motion vectors. Alternatively, the encoder computes the maximum difference between horizontal components of the available neighboring motion vectors and the median horizontal component value and computes the maximum difference between vertical components of the available neighboring motion vectors and the median vertical component value, and MVSS is the sum of the maximum differences.

For typical video sequences, the motion vectors for current units have a high correlation with those of the neighbors of the current units. This is particularly true when MVSS is small, indicating uniform or relatively uniform motion among neighboring units. In the example combined implementations, the encoder uses a monotonic mapping of MVSS to search window range (i.e., as MVSS increases in amount, search window range increases in size), which in turn is mapped to different start layers in the 4:2 layered block matching framework to start motion estimation for current units.

MVSS works well as an indicator of appropriate search window range when the current unit is in the middle of a region with strong spatial correlation among motion vectors, indicating uniform or relatively uniform motion in the region. Low values of MVSS tend to result in lower start layers for motion estimation (e.g., the 1:2 layer or 1:4 layer), unless the current unit appears to represent a transition in texture content.

For example, FIG. 7 shows a simple scene depicting a non-moving fence, dropping ball, and rising balloon in a reference picture (730) and current picture (710). Case 2 in FIG. 7 addresses contextual similarity for a second current unit (712) in the dropping ball in the current picture (710), and each of the neighboring units considered for the current unit (712) is also in the dropping ball. The strong motion vector correlation among motion vectors for the neighboring units (and strong texture correlation) results in the encoder selecting a low start layer for motion estimation for the second current unit (712).

MVSS also works well as an indicator of appropriate search window range when the current unit is in the middle of a region with weak spatial correlation among motion vectors, indicating discontinuous or complex motion in the region. High values of MVSS tend to result in higher start layers for motion estimation (e.g., the 8:1 layer).

Returning to FIG. 7, case I in FIG. 7 addresses contextual similarity for a first current unit (711) between the dropping ball and rising balloon in the current picture (710). The neighboring motion vectors exhibit discontinuous motion: the unit to the left of the current unit (711) has motion from the above left, the unit above the current unit (711) has little or no motion, and the unit above and right of the current unit (711) has motion from below and to the right. The weak motion vector correlation among neighboring motion vectors results in the encoder selecting a high start layer for motion estimation for the first current unit (711).

MVSS by itself is a good indicator of when the appropriate start layer is one of the highest layers or lowest layers. In some cases, however, MVSS does not accurately indicate an appropriate search window range when the current unit is in a transition between a region of strong spatial correlation among motion vectors and region of weak spatial correlation among motion vectors. This occurs, for example, at foreground/background boundaries in a video sequence.

As such, the encoder can compute several values based on the SAD value for the predicted motion vector (e.g., component-wise median of neighboring motion vectors) of the current unit and the SAD values of neighboring units:

$$\begin{matrix}SADDev = {max}_{a = L , U , UR} \vert {SAD}_{a} / {SAD}_{median} \vert , & ( 3 ) \\ SADCurrDev = {SAD}_{curr} / {SAD}_{median} , & ( 4 )\end{matrix}$$

where SAD_{median} is the median SAD value among available neighboring units to the left, above and above right of the current unit, computed at the 1:4 layer (or other final motion vector layer). SAD_{curr} is the SAD value of the current unit, computed at the predicted motion vector for the current unit at the 1:4 layer (or other final motion vector layer). SADDev measures deviation among the neighboring units' SAD values to detect a boundary between the neighboring units, which can also indicate a boundary for the current unit. SADCurrDev measures deviation between the current unit's SAD value and the SAD values of neighboring units, which can indicate of a boundary at the current unit. In other words, if SADCurrDev is large but MVSS and/or SADDev are small, there is a high probability that the current unit is at a boundary, and the encoder thus increases the starting search range for the current unit. In the combined implementations, the encoder computes SADDev and SADCurrDev regardless of the value of MVSS, and the encoder always considers SADDev and SADCurrDev as part of the contextual similarity metric. Alternatively, the encoder computes SADDev and SADCurrDev only when the value of MVSS leaves some ambiguity about the appropriate start layer for motion estimation.

Returning to FIG. 7, case 3 in FIG. 7 addresses contextual similarity for a third current unit (713) that is in the non-moving fence in the foreground in the current picture (710). The neighboring motion vectors exhibit uniform motion and yield a predicted motion vector for the current unit that references part of the dropping ball. The occlusion of the ball by the fence, however, results in a transition between the texture (or residual) of the current unit and the texture (or residuals) of the neighboring units. In terms of SAD, the transition causes a high value of SADCurrDev. The encoder thus selects a relatively high start layer for motion estimation for the third current unit (713).

Another example case (not shown in FIG. 7) of strong motion vector correlation but weak texture correlation occurs when a current unit has non-zero motion that is different than the motion of neighboring units. This can occur, for example, when one moving object overlaps another moving object. In such a case, when the predicted motion vector is used for the current unit, the residual for the current unit likely has high energy compared to the residuals of the neighboring units, indicating weak texture correlation in terms of SADCurrDev.

Jointly considering MVSS, SADDev, and SADCurrDev produces the following mapping relationship:

iSearchRange=mapping(MVSS, SADDev, SADCurrDev) (5),

where iSearchRange is a search window range for the current unit and is in turn related to the start layer, and mapping( ) is an mapping function that follows the guidelines articulated above. While the mapping relation is typically monotonic for all three variables, it is not necessarily linearly proportional, nor does each variable have the same weight. The details of the mapping of MVSS, SADDev, and SADCurrDev to start layers vary depending on implementation.

According to one example approach for selecting a start layer for motion estimation considering MVSS, SADDev, and SADCurrDev, if MVSS is small, the encoder starts at a lower layer such as 1:2 or 1:4, and if MVSS is large, the encoder starts at a higher layer such as 8:1 or 4:1. If MVSS is small, the encoder checks SADCurrDev to determine if the encoder should start at a higher layer. If SADCurrDev is small, the encoder still starts at a lower layer such as 1:2 or 1:4. If SADCurrDev is large, the encoder may increase the start layer to 2:1 or 1:1. SADDev affects the weight given to SADCurrDev when setting the start layer. If SADDev is low, indicating uniform or relatively uniform content, SADCurrDev is given less weight when setting the start layer. On the other hand, if SADDev is high, SADCurrDev is given more weight when setting the start layer. For example, a particular value of SADCurrDev, when considered in combination with a low SADDev value, might causes the start layer to move from 1:2 to 1:1. The same value of SADCurrDev, when considered in combination with a high SADDev value, might cause the start layer to move from 1:2 to 2:1.

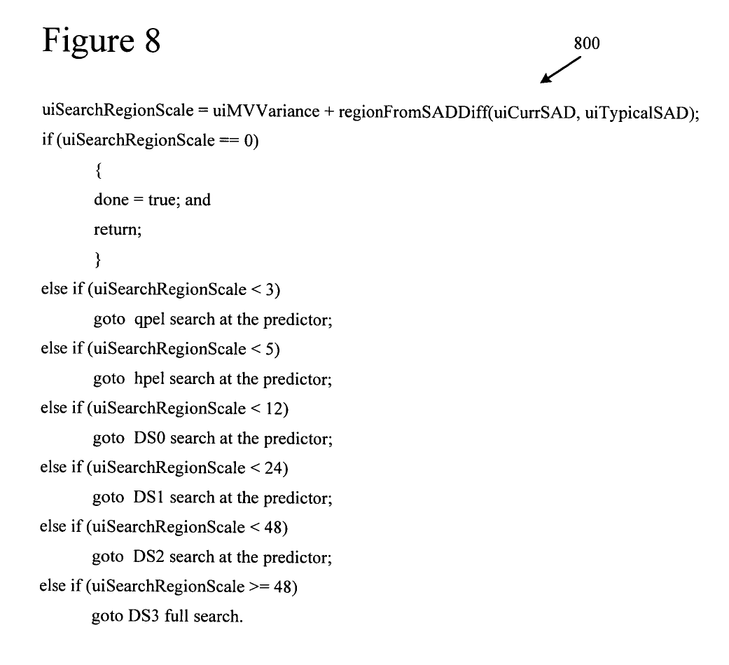

FIG. 8 shows pseudocode for another example approach for selecting the start layer for motion estimation for a current unit. The variable uiMVVariance is a metric such as MVSS, and the variables uiCurrSAD and uiTypicalSAD correspond to SADCurrDev and SADDev, respectively. The function regionFromSADDiff, which is experimentally derived, maps SAD “distance” to units comparable to motion vector “distance,” weighting motion vector distance relative to SAD distance as desired.

If the sum of motion vector and SAD distances is zero, the encoder skips motion estimation and uses the predicted motion vector (e.g., component-wise median of neighboring motion vectors) as the motion vector for the current unit. Otherwise, if the sum of the distances is less than a first threshold (in FIG. 8, the value 3), the encoder starts motion estimation at the 1:4 layer, using a 4-point walking diamond search centered at the predicted motion vector for the current unit. Similarly, if the sum of distances is less than a second threshold (in FIG. 8, the value 5), the encoder starts motion estimation at the 1:2 layer, using a 4-point walking diamond search centered at the predicted motion vector for the current unit. If necessary, the encoder checks the sum of distances against other thresholds, until the encoder identifies the start layer and associated search pattern for the current unit. For all but the 8:1 layer, the encoder centers the search at the predicted motion vector for the current unit, mapped to units of the appropriate layer.

Other routines for mapping contextual similarity metrics to start layers can use different switching logic and thresholds, depending on the metrics used, number of layers, associated search patterns, and desired thoroughness of motion estimation (e.g., how slowly or quickly the encoder should switch to a full search). The tuning of the contextual similarity metrics and mapping routines can also depend on the desired precision of motion vectors and type of filters used for sub-pixel interpolation. Higher precision motion vectors and interpolation filters tend to increase the computational complexity of motion estimation but often result in better matches, which can affect the quickness with which the encoder switches to a fuller search, and which can affect the weighting given to motion vector distance versus SAD distance.

Alternatively, the measure of statistical similarity for motion vectors is variance or some other statistical measure of similarity. The measures of texture similarity among neighboring units and between the current unit and neighboring units can be based upon reconstructed sample values, or use a metric other than SAD, or consider an average SAD value rather than a median SAD value. Or, the contextual similarity metric measures other and/or additional criteria for a current block, macroblock or other unit of video.

B. Flexible Starting Layer in Layered Motion Estimation.

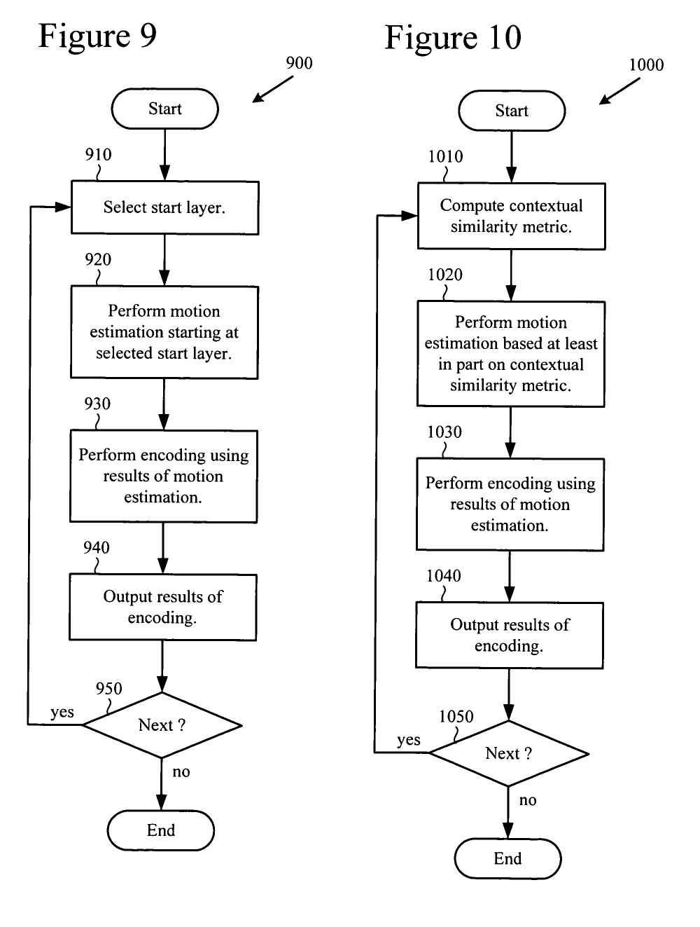

FIG. 9 shows a generalized technique (900) for selecting motion estimation start layers during layered motion estimation. Having an encoder select between multiple available start layers in a layered block matching framework provides a simple and elegant mechanism for varying the amount of resources used for block matching. An encoder such as the one described above with reference to FIG. 3 performs the technique (900). Alternatively, another tool performs the technique (900).

To start, the encoder selects (910) a start layer for a current unit of video, where the current unit is a block of a current video picture, macroblock of a current video picture, or other unit of video. The encoder selects (910) the start layer based upon a contextual similarity metric that measures motion vector similarity and/or texture similarity such as described with reference to FIGS. 7 and 8. Or, the encoder considers other and/or additional criteria when selecting the start layer, for example, a current indication of processor capacity or delay tolerance, or an estimate of the complexity of future video pictures. The number of available start layers and criteria used to select a start layer depend on implementation.

The encoder then performs (920) motion estimation starting at the selected start layer for the current unit. For example, the encoder starts at a 8:1 layer, finds seed motion vectors, maps the seed motion vectors to a 4:1 layer, and evaluates the seed motion vectors at the 4:1 layer, continuing through layers of motion estimation until reaching a final layer such as a 1:2 layer or 1:4 layer. Of course, in some cases, the motion estimation starts at the same layer (e.g., 1:2 or 1:4) that it ends. The selected start layer often indicates a search range and/or search pattern for the motion estimation. Other details of motion estimation, such as number of seeds, precision of final motion vectors, motion vector range, exit condition(s) and sub-pixel interpolation, vary depending on implementation.

The encoder performs (930) encoding using the results of the motion estimation for the current unit. The encoding can include entropy encoding of motion vector values and residual values. Or, the encoding can include a decision to intra-code the current unit, when the encoder deems motion estimation to be inefficient for the current unit. Whatever the form of the encoding, the encoder outputs (940) the results of the encoding.

The encoder then determines (950) whether to continue with the next unit. If so, the encoder selects (910) a start layer for the next unit and performs (920) motion estimation at the selected start layer. Otherwise, the motion estimation ends.

C. Contextual Similarity Metrics.

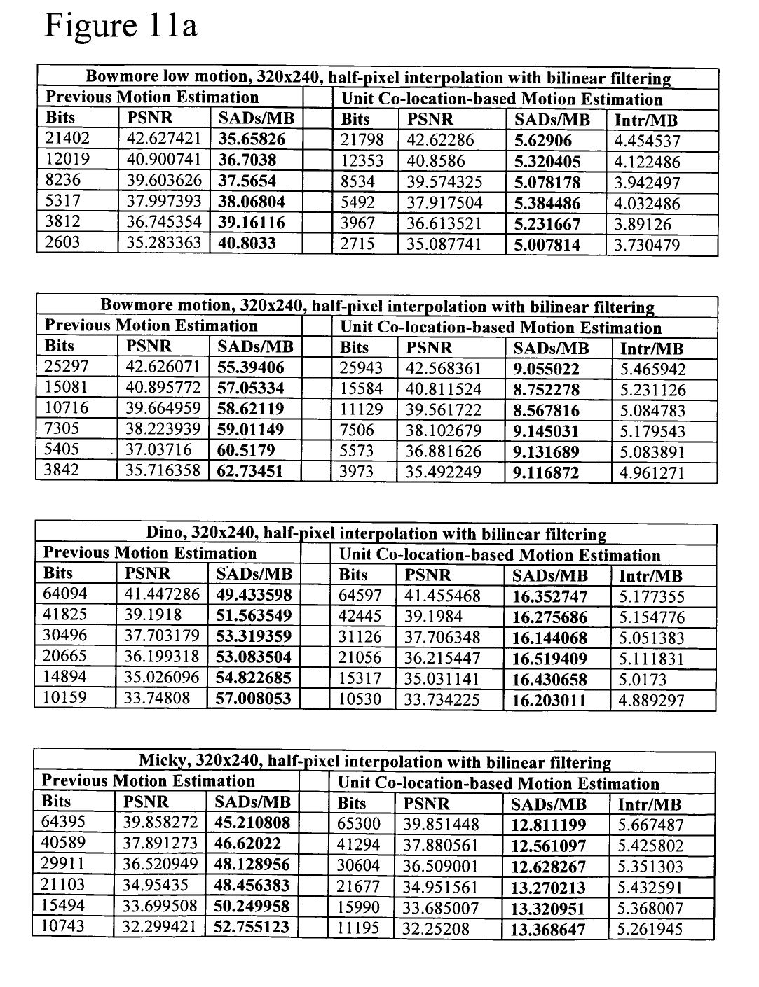

FIG. 10 shows a generalized technique (1000) for adjusting motion estimation based on contextual similarity metrics. The contextual similarity metrics provide reliable and efficient guidance in selectively varying the amount of resources used for block matching. An encoder such as the one described above with reference to FIG. 3 performs the technique (1000). Alternatively, another tool performs the technique (1000).

To start, the encoder computes (1010) a contextual similarity metric for a current unit of video, where the current unit is a block of a current video picture, macroblock of a current video picture, or other unit of video. For example, the contextual similarity metric measures motion vector similarity and/or texture similarity as described with reference to FIGS. 7 and 8. Alternatively, the contextual similarity metric incorporates other and/or additional information indicating the similarity of the current unit to its context.

The encoder performs (1020) motion estimation for the current unit, adjusting the motion estimation based at least in part on the contextual similarity metric for the current unit. For example, the encoder selects a start layer in layered motion estimation based at least in part on the contextual similarity metric. Or, the encoder adjusts another detail of motion estimation in a layered or non-layered motion estimation approach. The details of the motion estimation, such as search ranges, search patterns, numbers of seeds in layered motion estimation, precision of final motion vectors, motion vector range, exit condition(s) and sub-pixel interpolation, vary depending on implementation. Generally, the encoder devotes fewer resources to block matching for the current unit when motion vector prediction is likely to yield or get close to the final motion vector value(s). Otherwise, the encoder devotes more resources to block matching. The encoder performs (1030) encoding using the results of the motion estimation for the current unit. The encoding can include entropy encoding of motion vector values and residual values. Or, the encoding can include a decision to intra-code the current unit, when the encoder deems motion estimation to be inefficient for the current unit. Whatever the form of the encoding, the encoder outputs (1040) the results of the encoding.

The encoder then determines (1050) whether to continue with the next unit. If so, the encoder computes (1010) a contextual similarity metric for the next unit and performs (1020) motion estimation as adjusted according to the contextual similarity metric for the next unit. Otherwise, the motion estimation ends.

D. Results.

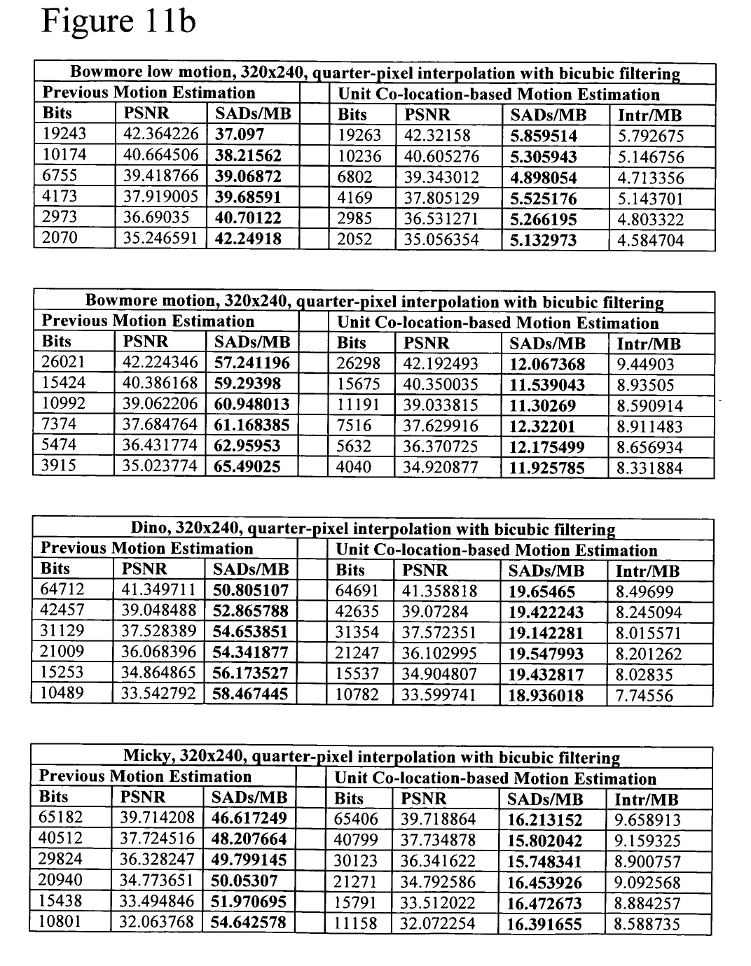

For some video sequences, with a combined implementation of the foregoing techniques, an encoder reduces the total number of block matching operations by a factor of 8× with negligible loss of coding efficiency. Specifically, a real time video encoder executing on XBox 360 hardware has incorporated the foregoing techniques in a combined implementation. The encoder has been tested for a number of clips ranging from indoor home video type clips to movie trailers, for different motion vector resolutions and interpolation filters. The tables shown in FIGS. 11a and 11b summarize results of the tests compared to results of motion estimation using the 2-layer hierarchical approach described in the Background.

The bit rates (“bits” for predicted pictures) and quality levels (in terms of PSNR) of output for the two different approaches are approximately constant for comparison of the two approaches, but the two approaches are evaluated at various bit rate/quality levels. For the unit co-location-based motion estimation approach, PSNR loss for the quarter-pixel motion estimation case is very small, typically less than 0.1db, with the two movie trailers showing close to no loss. In fact, the “Dino” clip even shows a slight PSNR gain. PSNR loss for half-pixel motion estimation using bilinear interpolation filtering is typically less than 0.2 db. Again, the two movie trailers show much less loss (<0.1 db). (One reason for worse performance for the half-pixel tests is that decisions were tuned for the quarter-pixel motion vectors in the unit co-location-based motion estimation.) Performance for half-pixel motion estimation using bicubic interpolation filtering is similar to that of half-pixel motion estimation using bilinear interpolation filtering. “Intr/MBs” indicates an average number of sub-pixel interpolations per macroblock.

The main comparison between the approaches is the number of SAD computations per macroblock (“SADs/MB”). Reducing the number of SAD computations per macroblock tends to make motion estimation faster and less computationally complex. The gain of the new scheme in terms of SADs/MB is typically between 3× to 8×, with low-motion ordinary camera clips showing the most improvement, and movie trailers showing the least improvement. The most improvement was achieved in motion estimation for the “Bowmore lowmotion” clips, going from an average of about 40 SADs/MB down to an average of a little more than 5 SADs/MB. On the average, the unit co-location-based motion estimation increased motion estimation speed by 5× to 6×, compared to the 2-layer hierarchical approach described in the Background.

E. Alternatives.

The preceding sections have described some alternative embodiments of unit co-location-based motion estimation techniques and tools. This section reiterates some of those alternative embodiments and describes a few more. Typically, these alternative embodiments involve extending the foregoing techniques and tools in straightforward manner to structurally similar algorithms that differ in specifics of implementation.
(1) A layered block matching framework can include lower spatial resolution layers (e.g., 16:1), higher spatial resolution layers (e.g., 1:8), and/or layers that relate to each other by a factor other than two horizontally and vertically.
(2) When the encoder selects between interpolation filter modes and/or motion vector resolutions, the encoder can use multiple instances of layers at the same spatial resolution. For example, the encoder can consider a 1:2 layer using bicubic interpolation and a 1:2 layer using bilinear interpolation. The encoder can output a final motion vector from one of these two 1:2 layers with or without further considering a 1:4 layer.
(3) The contextual similarity metrics can be modified or extended. For example, the metrics can take into account non-causal information (and not just the left and top units but also right unit, bottom unit, etc.) when the motion estimation is performed layer-by-layer (performing motion estimation for multiple units of a picture at one layer, then performing motion estimation for multiple units of the picture at a lower layer, and so on) rather than in a macroblock raster scan order for a unit at a time.
(4) Aside from performing the preceding unit co-location-based motion estimation techniques for macroblock motion estimation, when the encoder selects between one motion vector per macroblock and four motion vectors per macroblock, the encoder can incorporate the contextual similarity metrics into the 1 MV/4 MV decision. Or, the encoder can evaluate the 1 MV option and 4 MV option concurrently at one or more of the layers of motion estimation.
(5) Aside from performing the preceding unit co-location-based motion estimation techniques for motion estimation for progressive video pictures, an encoder can use the techniques for motion estimation for interlaced field pictures or interlaced frame pictures.
(6) Aside from performing the preceding unit co-location-based motion estimation techniques for motion estimation for P-pictures, an encoder can use the techniques for motion estimation for B-pictures, considering forward as well as backward motion vectors and distortion metrics according to various B-picture motion compensation modes.
(7) When the encoder switches motion vector ranges (e.g., extending motion vector ranges), the search window range of the full search can be enlarged accordingly.
(8) Aside from just considering contextual similarity of the current unit to neighboring units within the same picture, the encoder can alternatively or additionally consider contextual similarity of temporally neighboring units. The temporally neighboring units can be, for example, units along predicted motion trajectories in adjacent pictures.

Having described and illustrated the principles of my invention with reference to various embodiments, it will be recognized that the various embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of embodiments shown in software may be implemented in hardware and vice versa.

In view of the many possible embodiments to which the principles of my invention may be applied, I claim as my invention all such embodiments as may come within the scope and spirit of the following claims and equivalents thereto.

I claim:

1. A computer-implemented method comprising:
selecting a start layer for motion estimation from among plural available start layers for the motion estimation, each of the plural available start layers representing a reference video picture at a different spatial resolution;
for a current unit of samples in a current video picture, performing the motion estimation relative to the reference video picture starting at the selected start layer, wherein the motion estimation continues until the motion estimation completes for the current unit relative to the reference video picture at a final layer, and wherein the motion estimation finds motion information for the current unit;
using the motion information for the current unit when encoding the current unit; and
outputting results of the encoding of the current unit.

2. The method of claim 1 wherein the selecting is performed for the current unit, the method further comprising, for each of one or more subsequent units of samples in the current video picture, repeating the selecting, the performing, the using and the outputting.

3. The method of claim 1 wherein the current unit has plural neighboring units of samples in the current video picture, wherein the selecting comprises computing a contextual similarity metric for the current unit, and wherein the selecting is based at least in part on the contextual similarity metric for the current unit.

4. The method of claim 3 wherein the contextual similarity metric is based at least in part upon extent of similarity among motion vectors of the plural neighboring units.

5. The method of claim 3 wherein the contextual similarity metric is based at least in part upon a distortion metric for the current unit and/or an average or median distortion metric for the plural neighboring units.

6. The method of claim 3 wherein the selecting further comprises setting the start layer to have higher spatial resolution when the contextual similarity metric indicates strong motion vector correlation, thereby reducing number of block matching operations in the motion estimation for the current unit.

7. The method of claim 3 wherein the selecting further comprises setting the start layer to have lower spatial resolution when the contextual similarity metric indicates weak motion vector correlation, thereby enlarging effective search range in the motion estimation for the current unit.

8. The method of claim 3 wherein the selecting further comprises setting the start layer to have lower spatial resolution when the contextual similarity metric indicates weak texture correlation between the current unit and the plural neighboring units, thereby enlarging effective search range in the motion estimation for the current unit.

9. The method of claim 1 wherein each of the plural available start layers has an associated search pattern, and wherein the associated search patterns are different for at least two of the plural available start layers.

10. The method of claim 1 wherein the selected start layer comprises a down-sampled version of the reference video picture, and wherein the final layer comprises a sub-sampled version of the reference video picture.

11. The method of claim 1 wherein the selected start layer comprises an integer-sample version of the reference video picture, and wherein the final layer comprises a sub-sampled version of the reference video picture.

12. The method of claim 1 wherein the selected start layer comprises a sub-sampled version of the reference video picture, and wherein the final layer comprises the sub-sampled version of the reference video picture.

13. The method of claim 1 wherein the current video picture is a progressive video frame, interlaced video frame, or interlaced video field, wherein the current unit is a block or macroblock, and wherein the current video picture is a P-picture or a B-picture.

14. A computer-implemented method comprising:
computing a contextual similarity metric for a current unit of samples in a current video picture, wherein the current unit has one or more neighboring units of samples in the current video picture, and wherein the contextual similarity metric is based at least in part upon a texture measure for the current unit and a texture measure for the one or more neighboring units;
for the current unit, performing motion estimation relative to a reference video picture, wherein the motion estimation changes depending on the contextual similarity metric for the current unit, and wherein the motion estimation finds motion information for the current unit;
using the motion information for the current unit when encoding the current unit; and
outputting results of the encoding of the current unit.

15. The method of claim 14 wherein the contextual similarity metric is further based at least in part upon extent of similarity among motion vectors of the one or more neighboring units.

16. The method of claim 14 wherein the texture measure for the current unit is based at least in part upon a distortion metric for the current unit, and wherein the texture measure for the one or more neighboring units is based at least in part upon an average or median distortion metric for the neighboring units.

17. The method of claim 14 wherein the contextual similarity metric depends at least in part on a ratio between the texture measure for the current unit and the texture measure for the one or more neighboring units.

18. A video encoder comprising:
a frequency transform module for performing frequency transforms;
a quantization module for performing quantization;
an inverse quantization module for performing inverse quantization;
an inverse frequency transform module for performing inverse frequency transforms;
an entropy encoding module for performing entropy encoding; and
a motion estimation module for performing motion estimation in which a reference video picture is represented at plural layers having spatial resolutions that vary from layer to layer by a factor of two horizontally and a factor of two vertically, wherein a current unit covers the same effective area at each of the plural layers, wherein each of the plural layers has an associated search pattern, and wherein at least two of the plural layers have different associated search patterns.

19. The encoder of claim 18 wherein the plural layers include a lowest spatial resolution layer for which the associated search pattern is a full search, a highest spatial resolution layer for which the associated search pattern is a walking search, and another layer for which the associated search pattern is an n×n square.

20. The encoder of claim 18 wherein the plural layers includes a first layer, a second layer that accepts a first number of seeds from the first layer, and a third layer that accepts a second number of seeds from the second layer, and wherein the second number of seeds is less than the first number of seeds.
